(19) United States
(12) Patent Application Publication
(10) Pub. No.: US 2026/0209519 A1
(43) Pub. Date: Jul. 23, 2026

(54) FLAME RETARDANT POLYCARBONATE COMPOSITIONS

(71) Applicant: SABIC GLOBAL TECHNOLOGIES B.V., Bergen op Zoom (NL)

(72) Inventors: Fabrizio Zagros Sadafi, Bergen op Zoom (NL); John Hendricus Van der Wal, Bergen op Zoom (NL)

(21) Appl. No.: 19/140,022

(22) PCT Filed: Dec. 8, 2023
(86) PCT No.: PCT/EP2023/084951

§ 371 Date: Jun. 17, 2025

(30) Foreign Application Priority Data
Dec. 20, 2022 (EP) 22214785.2

(51) Int. Cl. C08L 83/10; C08L 69/00

(52) U.S. Cl. CPC C08L 83/10; C08L 69/00; C08L 2201/02; C08L 2205/025; C08L 2205/03

(57) ABSTRACT

A composition including based on the total weight of the composition (a) at least one poly(carbonate-siloxane) copolymer present in an amount from 25.0 wt. % to 55.0 wt. %; (b) at least one brominated polycarbonate present in amount from 25.0 wt. % to 55.0 wt. %; (c) glass fiber present in an amount from 12.0 wt. % to 20.0 wt. %; and (d) at least one polycarbonate homopolymer present in an amount from 6.0 wt. % to 20.0 wt. %, an article prepared from such a composition, and to the use of such composition.

### CROSS REFERENCE TO RELATED APPLICATIONS

This application is a National Stage application of PCT/EP2023/084951, filed Dec. 8, 2023, which claims the benefit of European Application No. 22214785.2, filed Dec. 20, 2022, both of which are incorporated by reference in their entirety herein.

### FIELD OF INVENTION

The invention relates to a polycarbonate compositions having improved flame retardant properties and to articles prepared from such polycarbonate compositions. The invention further relates to the use of such polycarbonate compositions for improving the flame retardant properties of components used in mass transportation.

### BACKGROUND

While most thermoplastic materials burn easily, the major requirement for such material to be used in mass transportation vehicle interiors is to comply the fire/flame resistance requirements set by different regulatory norms. For instance, the European rail industry is ruled by the EN45545-2 norm, which consists of three tests; heat release, smoke density and spread of flames. These define the standards a material needs to fulfill in order to be used for train interiors. The norm sets different risk and hazard levels that define the flame resistance standards a material needs to fulfil in order to be used for a certain application. Risks are classified with numbers ranging from 1 (most stringent) up to 26 (less stringent), 1 being associated with horizontal and vertical interior surfaces like ceilings, walls, window frames or display screens and 26 with small electronic parts.

The hazard levels are associated with the design and the operation of railway vehicles and are three; HL1 (less stringent), HL2 and HL3 (most stringent). In particular, to comply with EN45545-2 R1-HL2, a sample must have Heat Release (less than or equal)≤90.0 kW/m², Ds4 (less than or equal)≤300.0, VOF4 (less than or equal)≤600.0 (referring to smoke density) and CFE (greater than or equal to)≥20.0 kW/m² (referring to spread of flames).

Due to certain inherent advantages, such as its mechanical properties, relatively low density, ease of processing, ability to modify long term stability, polycarbonate based material are of high interest to the mass transportation industry for fabricating train and aircraft interiors. In addition, from the perspective of cost as sustainability consideration such as CO₂ emission reduction offered by polycarbonate as compared to competing materials such as aluminum or thermosets, there is an increased interest in using polycarbonate based materials for applications in the interiors of mass transportation systems, which are required to meet stringent flame regulatory criteria. Due to the challenge in enhancing the flame resistance properties, the use of polycarbonate based materials are currently limited to few specific applications such as armrests or lighting where the norms are relatively less stringent or have no regulatory requirements.

In the past, a possible approach for improving the flame/fire retarding properties of a thermoplastic material is by compounding polymers with flame retardant additives. However, flame retardant additives need to be selected and used judiciously and in limited quantity, as excess use of such additives may affect polymer properties such as rheology and mechanical properties thereby affecting processing of such polymers.

An alternate approach for improving the flame retardant properties of polycarbonates has been the use of polar functionalized polymer such as polyetherimide. For instance, industry practitioners have previously developed polyetherimide (PEI), polyphenylene oxide (PPO), which impart fire/flame resistance to polycarbonate based material. However, such polar functionalized polymer presents processing related disadvantages due to its higher density, lower mechanical properties and significantly higher costs and therefore may not be ideal for a price sensitive and high performance demanding markets like rail and aircraft industries.

Therefore, it is an object of the present invention to provide a polycarbonate based composition which has desirable flame retardant properties and may be used in mass transport applications. Yet another objective of the present invention is to provide a composition which complies with EN45545-2 R1-HL2 requirements without the need of adding additional flame retardants. Another, objective of the present invention is to provide articles prepared from such polycarbonate based compositions, which comply with EN45545-2 R1-HL2 flame retardant requirements.

### SUMMARY

Accordingly, the one or more objectives of the present invention is achieved by composition comprising or consisting of, based on the total weight of the composition:
(a) from 25.0 wt. % to 55.0 wt. % of at least one poly(carbonate-siloxane) copolymer;
(b) from 25.0 wt. % to 55.0 wt. % of at least one brominated polycarbonate;
(c) from 6.0 wt. % to 20.0 wt. % of at least one polycarbonate homopolymer; and
(d) from 12.0 wt. % to less than 20.0 wt. % of a glass fiber; wherein the polycarbonate homopolymer is free of bromine.

The sum of the components (a)-(d) and any optional additives is 100 wt. %. The optional additives, if present in the composition, may be present in an amount of not greater than 5.0 wt. %, preferably not greater than 2.5 wt. %, preferably not greater than 1.0 wt. %, based on the total weight of the composition.

### DETAILED DESCRIPTION

Preferably, wherein based on the total weight of the composition:
(a) the amount of poly(carbonate-siloxane) copolymer present is from 30.0 wt. % to 50.0 wt. %, preferably from 35.0 wt. % to 45.0 wt. %;
(b) the amount of brominated polycarbonate present is from 25.0 wt. % to 39.0 wt. %, preferably from 30.0 wt. % to 39.0 wt. %; and
(c) the amount of polycarbonate homopolymer present is from 8.0 wt. % to 18.0 wt. %.

The polycarbonate homopolymer is free of bromine thereby rendering such a homopolymer to be distinct from the brominated polycarbonate. The term “free of bromine” mean means that the polycarbonate homopolymer comprises 0.0 wt. % of polymeric units containing atomic bromine or bromine based compounds.

Advantageously, the inventors found that articles prepared from the composition of the present invention demonstrate excellent flame retardant properties and complies with the standards of EN45545-2 norms. In particular, articles prepared from the composition of the present invention complies with the stringent R1-HL2 EN45545-2 criteria, with the article having up to 3 mm material thickness. Although, polycarbonate based composition have been known in the past for flame retardancy and use in railway and aerospace components, the present invention specifically addressed the requirements of R1-HL2 EN45545-2 criteria.

The composition comprises less than 0.5 wt. %, preferably less than 0.01 wt. %, preferably 0.0 wt. %, based on the total weight of the composition, of additional flame retardant compounds. Preferably wherein the additional flame retardant compounds are selected from organic phosphates, polyetherimide (PEI), polyphenylene ether (PPE), aromatic organophosphorus compounds having two or more phosphorus-containing groups, organic compounds containing phosphorus-nitrogen bonds, halogenated flame retardants, inorganic flame retardants and combinations thereof.

The term “additional flame retardant compounds” means flame retardant compounds other than poly(carbonate-siloxane) copolymer, polycarbonate homopolymer, brominated polycarbonate, glass fiber, which may or may not have certain flame retardant properties of its own.

The inventors found that the composition demonstrates R1-HL2 EN45545-2 (“HL2”) criteria even without the need of using any additional flame retardant compounds.

For example, the composition has or is selected to have:
a smoke density after 4 minutes (Ds4) of less than or equal to 300.0, preferably less than or equal to 250.0, preferably less than or equal to 200.0, preferably less than or equal to 150.0, preferably less than or equal to 130.0, determined according to ISO 5659-2 on a 3 millimeter thick plaque at 50.0 kW/m²;
a smoke density (VOF4) of less than or equal to 600.0, preferably less than or equal to 500.0, preferably less than or equal to 400.0, preferably less than or equal to 300.0, preferably less than or equal to 250.0, determined in accordance with ISO 5659-2 on a 3.0 millimeter thick plaque at 50.0 kW/m²;
a maximum average heat release (MAHRE) of less than or equal to 90.0 kW/m², preferably less than or equal to or less than 80.0 kW/m², preferably less than or equal to or less than 60.0 kW/m² measured according to ISO 5660-1 on a 3 millimeter thick plaque at 50.0 kW/m²; and
a critical heat flux at extinguishment (CFE) of greater than or equal to 20.0 kW/m², preferably greater than or equal to 22.0 kW/m², preferably greater than or equal to 25.0 kW/m² determined in accordance with ISO 5658-2.

The composition may have a smoke density after 4 minutes (Ds4) from 55.0 to less than or equal to 300.0, preferably from 60.0 to less than or equal to 250.0, preferably from 60.0 to less than or equal to 200.0, preferably from 55.0 to less than or equal to 200.0, preferably from 60.0 to less than or equal to 100.0, determined according to ISO 5659-2 on a 3.0 millimeter thick plaque at 50.0 kW/m².

The composition may have a smoke density (VOF4) from 55.0 to less than or equal to 600.0, preferably from 80.0 to less than or equal to 550.0, preferably from 100.0 to less than or equal to 500.0, preferably from 100.0 to less than or equal to 500.0, preferably from 100.0 to less than or equal to 300.0, preferably from 100.0 to less than or equal to 250.0, determined in accordance with ISO 5659-2 on a 3.0 millimeter thick plaque at 50.0 kW/m².

The composition may have a maximum average heat release (MAHRE) from 25.0 to less than or equal to 90.0 kW/m², preferably from 35.0 to less than or equal to or less than 80.0 kW/m², preferably from 40.0 to less than or equal to or less than 60.0 kW/m² measured according to ISO 5660-1 on a 3 millimeter thick plaque at 50 kW/m².

The composition may have a critical heat flux at extinguishment (CFE) of greater than or equal to 20.0 kW/m² to at most 40.0 kW/m², preferably greater than or equal to 22.0 kW/m² to at most 35.0 kW/m², preferably greater than or equal to 25.0 kW/m² to at most 35.0 kW/m² determined in accordance with ISO 5658-2.

Accordingly, in an aspect of the invention, the invention relates to an article comprising the composition of the present invention, preferably wherein the article is suitable to be used in mass transportation systems. Preferably wherein the article is at least any one of a railway component, an aerospace component or an automobile component. The article may comprise the composition of the present invention in an amount of at least 90.0 wt. %, preferably at least 95.0 wt. %, preferably at least 98.0 wt. %, preferably at least 99.0 wt. %, preferably 100 wt. %, based on the total weight of the article.

In another aspect of the invention, the invention relates to the use of the composition according to the present invention for improving flame retardant properties of an article used in mass transportation systems.

In yet another aspect of the invention, the composition is free of poly(carbonate-siloxane-arylate ester) copolymer, wherein the poly(carbonate-siloxane-arylate ester) copolymer comprises or consists of repeat units of aromatic carbonate units, siloxane units, and aromatic ester (arylate) units.

### Poly(Carbonate-Siloxane) Copolymer

The composition comprises poly(carbonate-siloxane) copolymer, also referred to in the art as a polysiloxane-polycarbonate or a polydiorganosiloxane-carbonate.

The poly(carbonate-siloxane) copolymer, may be present in an amount from 25.0 wt. % to 55.0 wt. %, preferably from 30.0 wt. % to 50.0 wt. %, preferably from 35.0 wt. % to 45.0 wt. %, based on the total weight of the composition.

The poly(carbonate-siloxane) copolymer comprises or consists of repeat units of aromatic carbonate units and siloxane units. The poly(carbonate-siloxane) copolymer may comprise 70.0 to 98.0 wt %, preferably from 75.0 to 97.0 wt. % of aromatic carbonate units based on the total weight of the poly(carbonate-siloxane) copolymer. The poly(carbonate-siloxane) copolymer may comprise from 2.0 to 30.0 wt. %, preferably from 3.0 to 25.0 wt. % of siloxane units, based on the total weight of the poly(carbonate-siloxane) copolymer.

Preferably, the poly(carbonate-siloxane) copolymer has a silicon content of less than 3.0 wt. %, preferably less than 1.5 wt. %, preferably the silicon content is 1.0 wt. %, based on the total weight of the poly(carbonate-siloxane) copolymer.

Preferably, the poly(carbonate-siloxane) copolymer has a silicon content of greater than 0.0 wt. % and less than 3.0 wt. %, preferably greater than 0.0 and less than 1.5 wt. %, preferably the silicon content is 1.0 wt. %, based on the total weight of the poly(carbonate-siloxane) copolymer.

The poly(carbonate-siloxane) copolymer may have a Mw from 2,000 to 100,000 g/mol, preferably from 5,000 to 50,000 g/mol, preferably from 25,000 to 40,000 g/mol. Molecular weight as used herein is measured by gel permeation chromatography using a cross-linked styrene-divinyl benzene column, at a sample concentration of 1 milligram per milliliter, and as calibrated with polycarbonate standards. The poly(carbonate-siloxane) copolymer may have a polydispersity index of 2.0 to 3.0.

### Aromatic Carbonate Units

The aromatic carbonate units are repeating units of formula (1)

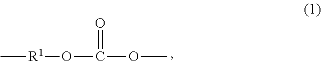

wherein at least 60 percent of the total number of R¹ groups are aromatic, or each R¹ contains at least one C₆₋₃₀ aromatic group.

Specifically, each R¹ may be derived from a dihydroxy compound such as an aromatic dihydroxy compound of formula (2) or a bisphenol of formula (3).

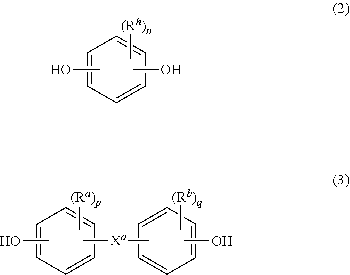

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁-12 alkyl, and p and q are each independently integers of 0 to 4, such that when p or q is less than 4, the valence of each carbon of the ring is filled by hydrogen.

Preferably, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which may be cyclic or acyclic, aromatic or non-aromatic, and can further comprise heteroatoms such as halogens, oxygen, nitrogen, sulfur, silicon, or phosphorous.

For example, X^{a} may be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Preferably, the aromatic carbonate units present in the poly(carbonate-siloxane) copolymer may comprise aromatic carbonate repeat units of formula

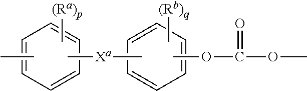

wherein R^{a} and R^{b} are each independently C₁₋₁₂ alkyl, C₁₋₁₂ alkenyl, C₃₋₈ cycloalkyl, or C₁₋₁₂ alkoxy, p and q are each independently 0 to 4, and X^{a} is a single bond, —O—, —S—, —S(O)—, —S(O)₂—, —C(O)—, a C₁₋₁₁ alkylidene of formula —C(R^{c})(R^{d})— wherein R^{e} and R^{d} are each independently hydrogen or C₁₋₁₀ alkyl, or a group of the formula —C(═R^{e})— wherein R^{e} is a divalent C₁₋₁₀ hydrocarbon group, preferably X^{a} is a C₁₋₁₁ alkylidene of formula —C(R^{c})(R^{d})— wherein R^{c} and R^{d} are each independently C₁₋₆ alkyl.

Preferably, wherein the aromatic carbonate units, are selected from bisphenol A carbonate units, resorcinol carbonate units, and combinations thereof. Preferably, wherein the aromatic carbonate units are derived from bisphenol A carbonate units and resorcinol carbonate units.

### Siloxane Units

The siloxane units of the poly(carbonate-siloxane) copolymer are present as polydiorganosiloxane (also referred to herein as “polysiloxane”) blocks comprise repeating diorganosiloxane (“siloxane”) units as in formula (7)

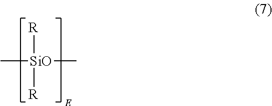

wherein each ‘R’ is independently a C₁₋₁₃ monovalent organic group. For example, ‘R’ may be independently be selected from a C₁-C₁₃ alkyl, C₁-C₁₃ alkoxy, C₂-C₁₃ alkenyl, C₂-C₁₃ alkenyloxy, C₃-C₆cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups may be fully or partially halogenated with fluorine, chlorine, bromine, or iodine, or a combination thereof. Preferably, where a transparent polysiloxane-polycarbonate is desired, ‘R’ is unsubstituted by halogen. Combinations of the foregoing ‘R’ groups may be used in the same copolymer.

The value of ‘E’ in formula (7) can vary widely depending on the type and relative amount of each component in the copolymer and composition containing the copolymer, the desired properties of the composition, and like considerations. Generally, E may have an average value from 2.0 to 1,000, preferably from 2.0 to 500.0, preferably from 2.0 to 200.0, preferably from 2.0 to 100.0, preferably from 5.0 to 60.0, preferably from 5.0 to 50.0, preferably from 5.0 to 20.0. Preferably, 2.0 to 200.0, preferably from 2.0 to 125.0, preferably from 5.0 to 125.0, preferably from 5.0 to 100.0, preferably from 5.0 to 50.0, preferably from 20.0 to 80.0, preferably from 5.0 to 20.0.

Preferably, ‘E’ ranges from 5.0 to 25.0, preferably from 5.0 to 15.0, preferably from 30.0 to 80.0, preferably from 30.0 to 70.0.

Preferably, the siloxane blocks are of formula (8)

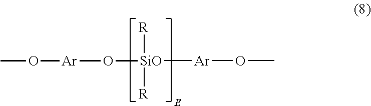

wherein ‘E’ is as defined in formula (7); each ‘R’ may be the same or different, and is as defined above; and ‘Ar’ may be the same or different, and is a substituted or unsubstituted C₆-C₃₀ arylene, wherein the bonds are directly connected to an aromatic moiety.

The ‘Ar’ groups in formula (8) may be derived from a C₆-C₃₀ dihydroxyarylene compound. The dihydroxyarylene compounds may be selected from 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing dihydroxy compounds can also be used.

Preferably, the ‘Ar’ group is derived from resorcinol. Preferably, the ‘Ar’ group is derived from bisphenol A.

Preferably, polydiorganosiloxane blocks are of formula (9)

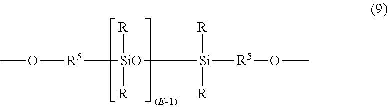

wherein ‘R’ and ‘E’ are as described in formula (7), and each R⁵ is independently a divalent C₁-C₃₀ organic group, and wherein the polymerized polysiloxane unit is the reaction residue of its corresponding dihydroxy compound.

Preferably, the polydiorganosiloxane blocks are of formula (10):

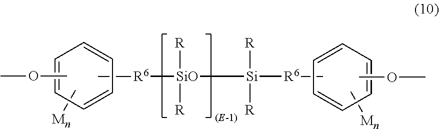

wherein ‘R’ and ‘E’ are as defined above. R⁶ in formula (10) is a divalent C₂-C₈ aliphatic. Each M in formula (10) may be the same or different, and may be a halogen, cyano, nitro, C₁-C₈alkylthio, C₁-C₈alkyl, C₁-C₈alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

Preferably, the siloxane units are of the formula:

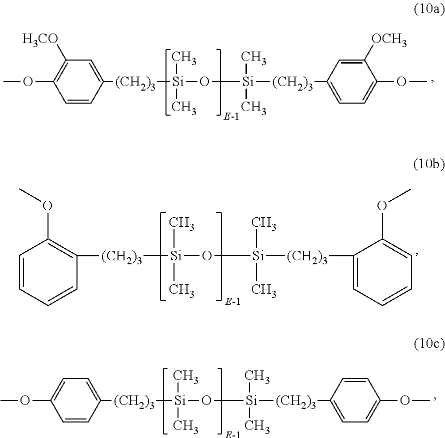

or a combination comprising at least one of the foregoing, wherein ‘E’ has an average value from 2.0 to 200.0, preferably from 2.0 to 125.0, preferably from 5.0 to 125.0, preferably from 5.0 to 100.0, preferably from 5.0 to 50.0, preferably from 20.0 to 80.0, preferably from 5.0 to 20.0.

Preferably wherein the poly(carbonate-siloxane) copolymer comprises or consists of repeat units derived from:
(i) aromatic carbonate units of the formula:

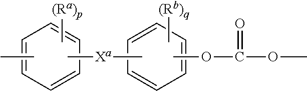

wherein R^{a} and R^{b} are each independently C₁₋₁₂ alkyl, C₁-12 alkenyl, C₃₋₈ cycloalkyl, or C₁₋₁₂ alkoxy, p and q are each independently 0 to 4, and X^{a} is a single bond, —O—, —S—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl, or a group of the formula —C(═R^{e})— wherein R^{e} is a divalent C₁₋₁₀ hydrocarbon group, preferably X^{a} is a C₁₋₁₁ alkylidene of formula —C(R^{c})(R^{d})— wherein R^{c} and R^{d} are each independently C₁₋₆ alkyl, preferably the aromatic carbonate units are derived from bisphenol A carbonate; and
(ii) siloxane units are selected from the formula:

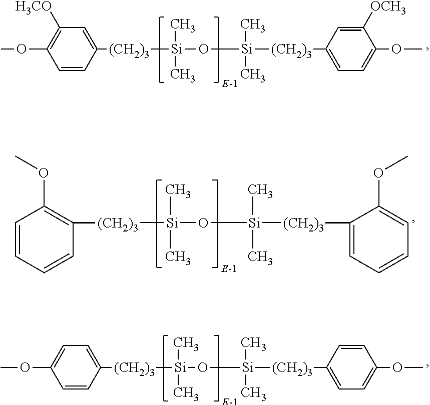

and any combination thereof, wherein ‘E’ has an average value from 2.0 to 200.0.

Preferably, the poly(carbonate-siloxane) copolymer comprises or consists of repeat units derived from bisphenol A (BPA) carbonate repeat units and dimethyl siloxane units.

For example, the poly(carbonate-siloxane) copolymer may be represented by the formula (25), where ‘x’ is an integer 1 to 100, or 5 to 85, or 10 to 70, or 15 to 65, or 40 to 60; y is an integer 10 to 30, and z is an integer 450 to 600.

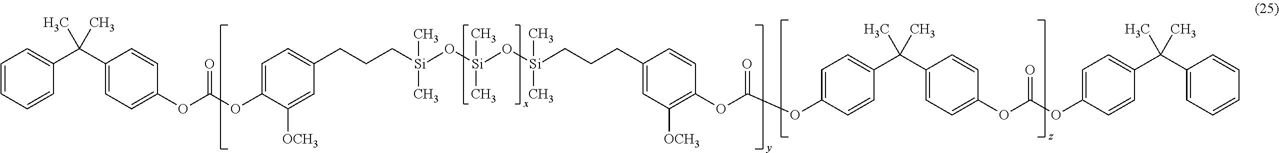

### Polycarbonate Homopolymer

The composition comprises at least one polycarbonate homopolymer. The polycarbonate homopolymer, may be present in an amount from 6.0 wt. % to 20.0 wt. %, preferably from 5.0 wt. % to 18.0 wt. %, preferably from 5.0 wt. % to 15.0 wt. %, preferably from 10.0 wt. % to 18.0 wt. %, preferably 12.0 wt. % to 20.0 wt. %, preferably 12.0 wt. % to 18.0 wt. %, based on the total weight of the composition.

The polycarbonate homopolymer may be selected from linear polycarbonate homopolymer, branched polycarbonate homopolymer, and combinations thereof.

Preferably, wherein the polycarbonate homopolymer is a linear polycarbonate homopolymer comprising or consisting of aromatic carbonate repeat units of the formula:

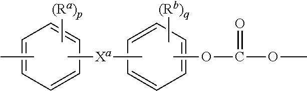

wherein R^{a} and R^{b} are each independently a C₁₋₁₂ alkyl group, C₁₋₁₂ alkenyl, C₃-8 cycloalkyl, or C₁₋₁₂ alkoxy, ‘p’ and ‘q’ are each independently integers from 0 to 4, and X^{a} is a single bond, —O—, —S—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl, or a group of the formula —C(═R^{e})— wherein R^{e} is a divalent C₁₋₁₀ hydrocarbon group.

Preferably X^{a} is a C₁₋₁₁ alkylidene of formula —C(R^{c})(R^{d})— wherein R^{e} and R^{d} are each independently C₁₋₆ alkyl. Preferably wherein the linear polycarbonate homopolymer comprises or consists of repeat units derived from bisphenol A carbonate.

The polycarbonate homopolymer may have a weight average molecular weight (Mw) of 10,000 to 50,000 g/mol. Molecular weight as used herein is measured by gel permeation chromatography using a crosslinked styrene-divinyl benzene column, at a sample concentration of 1 milligram per milliliter, and as calibrated with polycarbonate standards.

The branched polycarbonate homopolymer may comprise repeat units derived from aromatic carbonate units and units derived from a branching agent. The repeat aromatic carbonate units may have the formula:

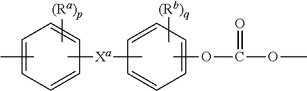

wherein R^{a} and R^{b} are each independently C₁₋₁₂ alkyl, C₁₋₁₂ alkenyl, C₃₋₈ cycloalkyl, or C₁₋₁₂ alkoxy, p and q are each independently 0 to 4, and X^{a} is a bridging group between the two arylene groups, and is a single bond, —O—, —S—, —S(O)—, —S(O)₂—, —C(O)—, a C₁₋₁₁ alkylidene of the formula —C(R^{c})(R^{d})— wherein R^{e} and R^{d} are each independently hydrogen or C₁₋₁₀ alkyl, or a group of the formula —C(═R^{e})— wherein R^{e} is a divalent C₁₋₁₀ hydrocarbon group.

The branching agent may comprise trimellitic trichloride, 1,1,1-tris(4-hydroxyphenyl) ethane or a combination of trimellitic trichloride and 1,1,1-tris(4-hydroxyphenyl) ethane. The branching agent may be present in an amount of greater than or equal to 0.2 mole %, based on the total moles of the branched polycarbonate.

### Brominated Polycarbonate

The composition comprises a brominated polycarbonate. For example, the brominated polycarbonate may be of formula (2), and include at least one R^{h} that is bromine, a bromine-substituted C₁₋₁₀ alkyl, or a bromine-substituted C₆₋₁₀ aryl. Alternatively, the brominated polycarbonate of formula (3), may include at least one R^{a} or R^{b} that is bromine.

Preferably, the brominated polycarbonate comprises or consists of repeat units derived from (i) brominated aromatic carbonate repeat units derived from 2,2′,6,6′-tetrabromo-4,4′-isopropylidenediphenol; and (ii) aromatic carbonate repeat units derived from bisphenol A.

Bromine repeat units of the brominated polycarbonate may be present in an amount of at least 5.0 wt %, preferably from 5.0 to 45.0 wt %, preferably from 10.0 to 35.0 wt %, based on the total weight of the brominated polycarbonate.

The brominated polycarbonate may be present in an amount from 25.0 wt. % to 55.0 wt. %, preferably from 25.0 wt. % to 40.0 wt. %, preferably from 25.0 wt. % to 39.0 wt. % preferably from 30.0 wt. % to 39.0 wt. %, based on the total weight of the composition.

### Glass Fiber

The composition may comprise a plurality of glass fibers. The glass fibers may be flat or round fibers. The flat glass fibers can have an elliptical cross-sectional area, while round fibers have a circular cross-sectional area, where the cross-sectional areas are measured perpendicular to the longitudinal axis of the fiber.

The glass fibers may be manufactured from “E-glass,” “A-glass,” “C-glass,” “D-glass,” “R-glass,” “S-glass,” as well as E-glass derivatives that are fluorine-free and/or boron-free. The glass fibers can have a diameter of 3 to 35 micrometers. The glass fibers can have a diameter of 3 to 25 micrometers, or 4 to 20 micrometers, or 8 to 15 micrometers. The glass fibers can comprise woven or non-woven fibers, for example, forming a reinforcing layer. The glass fibers may comprise chopped fibers. The chopped fibers may have a length of 0.5 millimeters (mm) to 2 centimeters (cm), or 1 mm to 1 cm. The glass fibers may be non-bonding or bonding. Examples of bonding glass fibers are T-120, commercially available from Nippon Electric Glass Co., Ltd.

The glass fiber may be present in an amount from 12.0 wt. % to 20.0 wt. %, preferably from 12.0 wt. % to 18.0 wt. %, based on the total weight of the composition.

The presence of glass fiber not only provides hardening of the char protective layer that is generated by poly(carbonate-siloxane) copolymer but also helps in synergistically to combine with the polycarbonate homopolymer to improve reduction of heat release and spread of flames.

Preferably, the composition comprises glass fiber present in amount of 12.0 wt. % to 20.0 wt. %, preferably from 12.0 wt. % to 18.0 wt. %, based on the total weight of the composition; and the polycarbonate homopolymer is present in an amount of 10.0 wt. % to 18.0 wt. %, preferably from 12.0 wt. % to 18.0 wt. %, based on the total weight of the composition.

The inventors further found that when other additive or fillers such as titanium oxide are used, the flame properties imparted to the composition are not effective as when titanium oxide is being used.

Preferably the composition comprises or consists of, based on the total weight of the composition:
(a) from 30.0 wt. % to 50.0 wt. % of at least one poly(carbonate-siloxane) copolymer;
(b) from 25.0 wt. % to 39.0 wt. % of at least one brominated polycarbonate;
(c) from 10.0 wt. % to 18.0 wt. % of at least one polycarbonate homopolymer; and
(d) from 12.0 wt. % to less than 18.0 wt. % of glass fiber; wherein the polycarbonate homopolymer is free of bromine.

Preferably the composition comprises or consists of, based on the total weight of the composition:
(a) from 35.0 wt. % to 45.0 wt. % of at least one poly(carbonate-siloxane) copolymer;
(b) from 30.0 wt. % to 39.0 wt. % of at least one brominated polycarbonate;
(c) from 10.0 wt. % to 18.0 wt. % of at least one polycarbonate homopolymer; and
(d) from 12.0 wt. % to less than 18.0 wt. % of glass fiber; wherein the polycarbonate homopolymer is free of bromine.

### Additives

An additive components may be used, comprising one or more additives selected to impart a desired property. The additive composition or individual additives may be mixed at a suitable time during the mixing of the components for forming the composition.

The additive components may include an anti-oxidant, impact modifier, flow modifier, filler (e.g., a particulate polytetrafluoroethylene (PTFE), glass particles (e.g., other than fibers, for example, spheres), carbon, mineral, or metal), reinforcing agent (e.g., other than glass fibers), heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, an additional flame retardant, anti-drip agent (e.g., a PTFE-encapsulated styrene-acrylonitrile copolymer (TSAN)), or a combination thereof.

The composition may include a combination of pigments, for example, titanium dioxide, carbon black, and chrome titanate. In general, the additives are used in the amounts generally known to be effective.

For example, the total amount of the additive components (other than any impact modifier or filler) may be from 0.0 to 5.0 wt. %, preferably from 0.001 to 2.0 wt %, preferably from 0.01 to 1.0 wt %, each based on the total weight of the composition.

### Method of Preparation

The composition may be prepared by melt mixing for example, in a batch mixer, the poly(carbonate-siloxane) copolymer, brominated polycarbonate, glass fiber and the polycarbonate homopolymer. The composition may be prepared by extruding the components in a twin-screw extruder to form extruded compositions. The mixed or extruded composition formed into a desired shape. The method forming is not limited and can include methods such as extruding, molding, coating, laminating, and the like.

The present invention will now be further elucidated based on the following non-limiting examples.

### EXAMPLES

Purpose: Demonstrate the flame retardant effects of compositions having a formulation prepared in accordance with the present invention and compare such properties with control formulations.

Material: For the purposes of this example the following materials were used:

TABLE 1

| Material | Description |
|---|---|
| Poly | EXL grade (ML7638-111N) from SHPP CAS# 202483-49-6: |
| (carbonate- | Poly(bisphenol A carbonate-dimethylsiloxane) copolymer |
| siloxane) | produced via interfacial polymerization, 20.0 wt % siloxane, |
| copolymer | average siloxane block length = 45 units (D45), Mw = 29,000 |
| | to 31,000 g/mol as per GPC using polycarbonate standards, |
| | PCP end-capped, polydispersity = 2 to 3; comprising 1 wt % |
| | of total silicon content. |
| Poly- | Polycarbonate Grade 105-111, CAS# 111211-39-3: |
| carbonate | A linear poly(bisphenol A carbonate), Mw = 30,000- |
| homo- | 31,000 g/mol per GPC using bisphenol A homopolycarbonate |
| polymer | standards. |
| Brominated | A copolymer of polycarbonate derived from |
| poly- | tetrabromobisphenol A (TBBPA) and bisphenol A (BPA) |
| carbonate | co-carbonate (about 30 mol % TBBPA) with a Mw of |
| | about 22,500 g/mol, PCP endcap. |
| Glass fibers | Chopped glass fibers having a 14 micrometer diameter |

Process for preparing samples: The compositions used in the examples were prepared by first extruding the components in a twin-screw extruder under the processing conditions described in Table 2A to form extruded compositions. The extruded compositions were then dried and extruded into 400 mm wide sheets of different thicknesses by using a Cincinnati extruder under the processing parameters described in Table 2B.

As used herein, ° C. stands for degrees Celsius, rpm stands for revolutions per minute, kg/hr stands for kilograms per hour and m/min stands for meters per minute.

TABLE 2A

| Parameters | Unit | Value | | Unit | Value |
|---|---|---|---|---|---|
| Feed (Zone 0) Temp | ° C. | 50 | | | |
| Zone 1 Temp | ° C. | — | Zone 10 Temp | ° C. | — |
| Zone 2 Temp | ° C. | 200 | Zone 11 Temp | ° C. | — |
| Zone 3 Temp | ° C. | 220 | Zone 12 Temp | ° C. | — |
| Zone 4 Temp | ° C. | 250 | Die Temp | ° C. | 250 |
| Zone 5 Temp | ° C. | 250 | Screw speed | rpm | 450 |
| Zone 6 Temp | ° C. | 250 | Throughput | kg/hr | max. 35 |
| Zone 7 Temp | ° C. | 250 | Torque | % | — |
| Zone 8 Temp | ° C. | 250 | Vacuum 1 | bar | 0.7 |
| Zone 9 Temp | ° C. | 250 | Vacuum 2 | bar | |

TABLE 2B

| Parameters | Unit | Values |
|---|---|---|
| Zone 1 temp | ° C. | 190 |
| Zone 2 temp | ° C. | 200 |
| Zone 3 temp | ° C. | 210 |
| Zone 4 temp | ° C. | 225 |
| Zone 5 temp | ° C. | 235 |
| Zone 6 temp | ° C. | 240 |
| Zone 7 temp | ° C. | 250 |
| Zone 8 temp | ° C. | 260 |
| Roll 1 | ° C. | 120 |
| Roll 2 | ° C. | 125 |
| Roll 2 | ° C. | 130 |
| Roll speed | m/min | 0.4 |

Test standards: The flame resistance characterization of Examples 1 to 6 was performed according to EN45545-2 and included heat release (ISO 5660-1), smoke density (ISO 5659-2), and flame spread (ISO 5658-2) measurements. The requirements needed in order to receive a passing rating according to R1-HL2 and R1-HL3 are listed in Table 3. The R1-HL2 and R1-HL3 requirements were measured using samples having a 3.0 mm thicknesses.

TABLE 3

| Measurement | Parameter | Test Method | HL2 |
|---|---|---|---|
| Heat Release | MAHRE | ISO 5660-1 | less than |
| | | on a 3 millimeter | or equal |
| | | thick plaque | to 90 kW/m² |
| | | at 50 kW/m² | |
| Smoke Density | Ds4 | ISO 5659-2 on a | less than |
| | | 3 mm thick plaque | or equal |
| | | at 50 kW/m² | to 300 |
| | VOF4 | ISO 5659-2 on a | less than |
| | | 3 mm thick plaque | or equal |
| | | at 50 kW/m² | to 600 |
| Critical Heat Flux | CFE | ISO 5658-2 | greater than |
| at Extinguishment | | | or equal to |
| | | | 20 kW/m² |

Various compositions were prepared via a design of experiment (DOE) approach by using a mixture design space and analyzed for flame ratings according to EN45545-2 norm.

Results and Conclusion: Table 4 provides the relative amount of the components for the samples.

TABLE 4

| | Poly(carbonate- | | | |
|---|---|---|---|---|
| | siloxane) | Brominated | Polycarbonate | Glass |
| | copolymer | polycarbonate | homopolymer | fiber |
| Sample No. | (wt. %) | (wt. %) | (wt. %) | (wt. %) |
| IE1 | 35.0 | 35.0 | 15.0 | 15.0 |
| (inventive) | | | | |
| IE2 | 45.0 | 30.0 | 10.0 | 15.0 |
| (inventive) | | | | |
| IE3 | 40.0 | 35.0 | 10.0 | 15.0 |
| (inventive) | | | | |
| IE4 | 37.5 | 37.5 | 12.5 | 12.5 |
| (inventive) | | | | |
| CE1 | 45.0 | 35.0 | 5.0 | 15.0 |
| (comparative) | | | | |
| CE2 | 45.0 | 40.0 | 0.0 | 15.0 |
| (comparative) | | | | |
| CE3 | 45.0 | 35.0 | 0.0 | 20.0 |
| CE4 | 40.0 | 40.0 | 0.0 | 20.0 |
| CE5 | 35.0 | 45.0 | 0.0 | 20.0 |

Table 5 provides the flame retardant performance of the samples.

TABLE 5

| | Heat | | | | Test |
|---|---|---|---|---|---|
| | release/ | | | | Compliant |
| | kW/m² | Ds4 | VOF4 | CE4 | with |
| IE | 64.2 | 260 | 506 | 21 | HL2 |
| IE2 | 66.4 | 256 | 577 | 23.7 | HL2 |
| IE3 | 61.7 | 179 | 207 | 20 | HL2 |
| IE4 | 46 | 286 | 414 | 22.8 | HL2 |
| CE1 | 67.1 | 289 | 610 | 25 | Does not pass |
| CE2 | 58.8 | 309 | 581 | 23.5 | Does not pass |
| CE3 | 66.3 | 353 | 638 | 25.4 | Does not pass |
| CE4 | 63 | 311 | 597 | 23 | Does not pass |
| CE5 | 61 | 316 | 591 | 25 | Does not pass |

As is evident from the data provided under Table 5, that the samples prepared in accordance with the present invention pass the HL2 flame retardant test. Accordingly, articles prepared from these formulations can be used in mass transportation systems which require strict adherence to these test standards.

From the above table, the presence of each of the components at a specific proportion relative to the other contributed to the meeting of the requirements of HL2.

Further, the inventors found that even when the formulations used identical components but blended in different proportions, the required flame retardant performance was not obtained. For example, comparative sample CE1 had identical components but blended at different proportion compared from IE1-IE4. However each of IE1-IE4 samples passed the HL2 flame retardant test while the sample CE1 did not. This is surprising, as although poly(carbonate-siloxane) copolymer used in the examples have certain degree of flame retardant properties it is evident that only when the ingredients were formulated in the proportion as prescribed under the present invention, the desired flame retardant effects under HL2 criteria were achieved even without the need of adding additional flame retardant additives.

1. A composition comprising or consisting of, based on the total weight of the composition:
(a) from 25.0 wt. % to 55.0 wt. % of at least one poly(carbonate-siloxane) copolymer;
(b) from 25.0 wt. % to 55.0 wt. % of at least one brominated polycarbonate;
(c) from 6.0 wt. % to 20.0 wt. % of at least one polycarbonate homopolymer; and
(d) from 12.0 wt. % to less than 20.0 wt. % of glass fiber; wherein the polycarbonate homopolymer is free of bromine.

2. The composition of claim 1, wherein based on the total weight of the composition:
(a) the amount of poly(carbonate-siloxane) copolymer present is from 30.0 wt. % to 50.0 wt. %;
(b) the amount of brominated polycarbonate present is from 25.0 wt. % to 39.0 wt. %; and
(c) the amount of polycarbonate homopolymer present is from 8.0 wt. % to 18.0 wt. %.

3. The composition according to claim 1, wherein the poly(carbonate-siloxane) copolymer has a silicon content of less than 3.0 wt. %, based on the total weight of the poly(carbonate-siloxane) copolymer.

4. The composition according to claim 1, wherein the glass fiber is present in amount of 12.0 wt. % to 20.0 wt. %, based on the total weight of the composition; and the polycarbonate homopolymer is present in an amount of 10.0 wt. % to 18.0 wt. %, based on the total weight of the composition.

5. The composition according to claim 1, wherein based on the total weight of the composition, the composition comprises or consists of:
(a) from 30.0 wt. % to 50.0 wt. % of at least one poly(carbonate-siloxane) copolymer;
(b) from 25.0 wt. % to 39.0 wt. % of at least one brominated polycarbonate;
(c) from 10.0 wt. % to 18.0 wt. % of at least one polycarbonate homopolymer; and
(d) from 12.0 wt. % to less than 18.0 wt. % of glass fiber; wherein the polycarbonate homopolymer is free of bromine.

6. The composition according to claim 1, wherein based on the total weight of the composition, the composition comprises or consists of:
(a) from 35.0 wt. % to 45.0 wt. % of at least one poly(carbonate-siloxane) copolymer;
(b) from 30.0 wt. % to 39.0 wt. % of at least one brominated polycarbonate;
(c) from 10.0 wt. % to 18.0 wt. % of at least one polycarbonate homopolymer; and
(d) from 12.0 wt. % to less than 18.0 wt. % of glass fiber; wherein the polycarbonate homopolymer is free of bromine.

7. The composition according to claim 1, wherein the polycarbonate homopolymer is selected from linear polycarbonate homopolymer, branched polycarbonate homopolymer and combinations thereof.

8. The composition according to claim 1, wherein the polycarbonate homopolymer is a linear polycarbonate homopolymer comprising or consisting of aromatic carbonate repeat units of the formula: 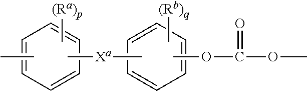
wherein
R^{a} and R^{b} are each independently a C₁₋₁₂ alkyl group, C₁₋₁₂ alkenyl, C₃₋₈ cycloalkyl, or C₁₋₁₂alkoxy, p and q are each independently integers from 0 to 4, and X^{a} is a single bond, —O—, —S—, —S(O)—, —S(O)₂—, —C(O)—, a C₁₋₁₁ alkylidene of formula —C(R^{c}) (R^{d})— wherein R^{c} and R^{d} are each independently hydrogen or C₁₋₁₀ alkyl, or a group of the formula-C(═R^{e})— wherein R^{e} is a divalent C₁₋₁₀ hydrocarbon group.

9. The composition according to claim 8, wherein the linear polycarbonate homopolymer comprises or consists of repeat units derived from bisphenol A carbonate.

10. The composition according to claim 1, wherein the poly(carbonate-siloxane) copolymer comprises or consists of repeat units derived from: (i) aromatic carbonate units of the formula: 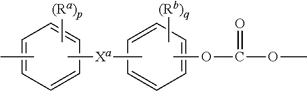
wherein
R^{a} and R^{b} are each independently a C₁₋₁₂ alkyl group, C₁₋₁₂ alkenyl, C₃₋₈ cycloalkyl, or C₁₋₁₂alkoxy, p and q are each independently integers from 0 to 4, and X^{a} is a single bond, —O—, —S—, —S(O)—, —S(O)₂—, —C(O)—, a C₁₋₁₁ alkylidene of formula —C(R^{c})(R^{d})— wherein R^{c} and R^{d} are each independently hydrogen or C₁₋₁₀ alkyl, or a group of the formula —C(═R^{e})— wherein R^{e} is a divalent C₁₋₁₀ hydrocarbon group; and
(ii) siloxane units selected from the formula: 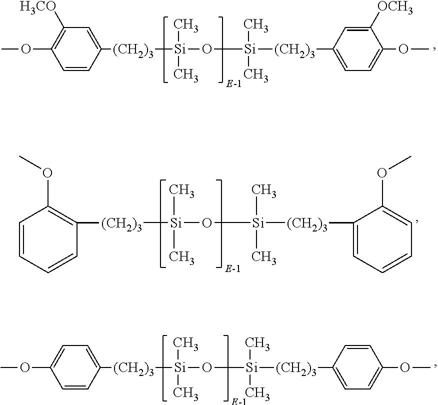
and any combination thereof, wherein ‘E’ has an average value of 2.0 to 200.0.

11. The composition according to claim 1, wherein the brominated polycarbonate comprises repeat units derived from (i) brominated aromatic carbonate repeat units derived from 2,2′,6,6′-tetrabromo-4,4′-isopropylidenediphenol; and (ii) aromatic carbonate repeat units derived from bisphenol A.

12. The composition according to claim 1, wherein the composition comprises less than 0.5 wt. % based on the total weight of the composition, of additional flame retardant compounds.

13. The composition according to claim 1, wherein the composition has or is selected to have:
a smoke density after 4 minutes (Ds4) of less than or equal to 300.0 determined according to ISO 5659-2 on a 3.0 millimeter thick plaque at 50.0 kW/m²;
a smoke density (VOF4) of less than or equal to 600.0 determined in accordance with ISO 5659-2 on a 3.0 millimeter thick plaque at 50.0 kW/m²;
a maximum average heat release (MAHRE) of less than or equal to 90.0 kW/m² measured according to ISO 5660-1 on a 3.0 millimeter thick plaque at 50 kW/m²; and
a critical heat flux at extinguishment (CFE) of greater than or equal to 20.0 kW/m² determined in accordance with ISO 5658-2.

14. An article comprising the composition according to claim 1.

15. A method for improving flame retardant properties of an article, the method comprising forming the composition according to claim 1 into an article used in mass transportation systems.
